(19) United States
(12) Patent Application Publication
(10) Pub. No.: US 2008/0105186 A1
(43) Pub. Date: May 8, 2008

(54) Boat Lifting Apparatus and Method

(75) Inventors: Carl E. Johns JR., Cocoa, FL (US); Stephen G. Johns, Cocoa, FL (US)

Correspondence Address: CARL M. NAPOLITANO, PH.D.;ALLEN, DYER, DOPPELT, MILBRATH & GILCHRIST, P.A., 255 SOUTH ORANGE AVE., SUITE 1401, P.O. BOX 3791, ORLANDO, FL, 32802-3791, US

(73) Assignee: SEALIFT, INC., Cocoa, FL (US)

(21) Appl. No.: 11/936,850

(22) Filed: Nov. 8, 2007

Related U.S. Application Data
(63) Continuation-in-part of application No. 11/090,827, filed on May 10, 2005, now Pat. No. 7,293,521.

(51) Int. Cl. B63B 35/40; B66C 13/00

(52) U.S. Cl. 114/259; 114/373

(57) ABSTRACT

A lifting apparatus for raising and lowering a vessel such as personal watercraft, jet skis, inflatables may be mounted to a transom on boats, to bulkheads and to docks for raising and lowering vessels. A single actuator is used for raising and lowering a cradle that supports the vessel. An arm driven by the actuator is pivotally mounted to a mounting bracket and is extendable to different lengths. The cradle includes a self-leveling carriage that may use rollers to roll on a curved surface of the cradle allowing the supported watercraft to remain in a substantially level position thereon. An adjustable swivel mount is used to adjust the cradle to a desired horizontal orientation.

### CROSS-REFERENCE TO RELATED APPLICATIONS

This application is a continuation-in-part application and claims the benefit of U.S. application Ser. No. 11/090,827 for “Hydraulic Transom Lift,” filed May 10, 2005 and issuing as U.S. Pat. No. 7,293,521, the disclosure of which is hereby incorporated by reference herein in its entirety, and commonly owned.

### FIELD OF THE INVENTION

The present invention relates to watercrafts and in particular to devices, apparatus and systems for raising and lowering watercrafts such as jet skis, inflatables, rowboats, small personal watercrafts, and the like, as well as other types of vessels from swim platforms on the back of larger pleasure crafts, from docks, from bulkheads, and the like.

### BACKGROUND OF THE INVENTION

Small craft lift devices for raising and lowering small craft type boats into and out of the water which can be mounted off larger boats are well known. However, they are also well known to have limitations and problems that affect their applications.

Old versions of the small craft lift devices have used pulleys, and block and tackle arrangements with lines to raise and lower a fixed cradle or platform. However, the lines and pulleys and blocks and tackle required can easily become tangled, and difficult to operate. Also, these old type devices generally require hand operated cranks that are not desirable nor efficient or practical for the person operating these lift devices. Still furthermore, the fixed platforms and cradles used are also problematic since many include surfaces which may scratch, mar and damage the hulls and bottoms of the small type boats. See for example, U.S. Pat. No. 582,069 to Leslie and U.S. Pat. No. 2,185,083 to Horton.

Many current type small craft boat lifts require complex and expensive arrangements of plural hydraulic type cylinders to raise and lower a platform or fixed cradle. These lifts often locate the small crafts at a distance from the main boat. The fixed platforms and cradles used are also problematic since many include surfaces which may scratch, mar and damage the hulls and bottoms of the small type boats. See for example, U.S. Pat. No. 5,544,606 to Schmidt, Jr.; U.S. Pat. No. 6,003,463 to Giesler; U.S. Pat. No. 6,327,992 to Martin; U.S. Pat. No. 6,474,256 to Vogel: U.S. Pat. No. 6,782,842 to Alvord; and U.S. Pat. No. 6,786,170 to Trowbridge. Thus, the need exists for solutions to the above problems with the prior art.

### SUMMARY OF THE INVENTION

Features and advantages of a lifting apparatus in accordance with the present invention may be provided by an apparatus comprising a frame, an arm having proximal and distal ends, wherein the proximal end is rotatably connected to the frame, a cradle carried by the arm distal end, wherein rotation of the arm lowers and raises the cradle, a carriage slidable on an upper surface of the cradle, and upper and lower sliding elements attached to the carriage, wherein at least two upper elements are operable along the upper surface of the cradle, and wherein at least one lower element is operable along a lower surface of the cradle, the upper and the lower elements allowing the carriage to slide along the cradle in a substantially level position while the cradle is being raised and lowered by the arm rotation.

One lifting apparatus may comprise a frame, an arm having proximal and distal ends, wherein the proximal end is rotatably connected to the frame, a cradle carried by the arm, wherein rotation of the arm lowers and raises the cradle, a carriage slidable on the cradle, and a swivel mount locking the cradle to the arm, wherein the swivel mount is adjustably mounted to the arm for fixing the cradle at a preselected orientation thereto.

The swivel mount may comprise a swivel plate having a fastener securing the arm in a preselected orientation relative to the cradle, a swivel adjustment member pivotally connected to the swivel plate, and adjustment means for modifying the preselected orientation by a rotation of the swivel adjustment member relative to the swivel plate. Yet further, the swivel mount may comprise a side plate fixedly attached to the cradle, a swivel plate fixedly attached to a free end of the arm, the swivel plate mating with the side plate for slidable movement therewith, and a fastener securing the side plate to the swivel plate in the preselected orientation.

Embodiments of the present invention provide a practical, efficient, simple and easy to operate lifting apparatus and system for raising and lowering watercrafts such as jet skis, inflatables, rowboats, personal watercrafts, and the like, and other vessels from swim platforms on the back of larger pleasure crafts, docks, bulkheads, and the like.

Embodiments of the present invention may employ only a single actuator, which actuator may include a single fluid cylinder and single fluid operated piston. A cradle may include supports that avoid marring or damaging the underside of the watercrafts being raised and lowered.

A lifting apparatus or device for raising and lowering water crafts may include a frame attached to a support, a rotatable crank attached to the frame, a fluid operated actuator having one end attached to the frame and an another end attached to the crank member, an arm having a first end attached to the crank member and a second end, and a cradle supporting a watercraft which is attached to the second end of the arm, wherein the fluid actuator lowers and raises the cradle with the supported watercraft.

The rotatable crank may include a rotatable crank shaft with a crank bracket fixably attached to the rotatable crank shaft, the one end of the fluid operated actuator pivotably attached to the crank bracket and the first end of the arm fixably attached to the rotatable crank shaft. The arm supporting the cradle may include a telescoping section that allows the arm to have a varying length.

The cradle may have a concave curved surface on the cradle, and a self leveling carriage positioned on the concave curved surface of the cradle, the carriage allowing the watercraft to remain in a substantial level position while the arm and the attached cradle are being raised and lowered.

The cradle may have rollers or sliding elements between portions of the carriage and the cradle for allowing the carriage to roll relative to the cradle while the arm and the attached cradle are being raised and lowered. The rollers can include a first set of three rollers arranged in a triangular pattern on one side of the carriage, and a second set of three rollers arranged in a triangular pattern on another side of the carriage, the first and second sets of rollers allowing the carriage to roll relative to the cradle.

The carriage can also include upright supports pivotally attached to the carriage, the pivotal upright supports allowing the water craft to be firmly supported in a stable position to the carriage.

A swivel mount can be used for locking the cradle to the arm. The swivel mount can include a swivel plate having a fastener for holding the arm in a selected fixed orientation position relative to the cradle. The fastener can include a first fastener along one side of the arm, and a second fastener along another side of the arm, wherein the first and the second fasteners lock the cradle in the selected fixed orientation position relative to the cradle.

An extra securing latch can be used for holding the arm in the raised position. and the latch can use another fluid operated actuator for opening and closing the latch.

The lift can be attached to an angled surface such as a bottom transom, such as a swim platform on a large watercraft. The lift can also be attached underneath a horizontal surface such as a dock. The lift can also be mounted on wall type surfaces such as along a bulkhead.

In another version, the lift can attach underneath a swim platform on the back of a pleasure boat for raising and lowering a personal watercraft such as a jet ski inflatable, and the like. The lift can have a lift arm with one end in a fixed perpendicular connection to one end of a crank arm. The second end of the lift arm is fixed to a cradle having a carriage supported thereon by a rollers. A perpendicular connection point between the crank arm and the lift arm can be pivotally connected to a mount that is attached underneath the swim platform. A single hydraulic cylinder has a piston that moves a second end of the crank arm from a first position to a second position. In the first position, the lift arm is raised, and in the second position, the lift arm is lowered and the cradle is in a lowered position. While the cradle moves from an up position to a lowered position, the supported personal watercraft being held by the carriage rolls off the cradle and into the water.

Further advantages of the invention will be apparent from the following detailed description of the presently preferred embodiments which are illustrated schematically in the accompanying drawings.

### BRIEF DESCRIPTION OF THE DRAWINGS

For a fuller understanding of the invention, reference is made to the following detailed description, taken in connection with the accompanying drawings illustrating various embodiments of the present invention, in which:

FIG. 1 is a back perspective view of the lift in an up position;

FIG. 2 is a back perspective view of the lift of FIG. 1 in a down position;

FIG. 3 is a side view of the lift of the preceding figures in an up position attached to a transom (swim platform) on a larger boat;

FIG. 4 is a side view of the lift of FIG. 3 in a down position;

FIG. 5 is a side view of the lift in an up position attached to a dock;

FIG. 6 is a side view of the lift of FIG. 5 in a down position;

FIG. 7 is a front view of the lift of FIG. 1 along arrow F;

FIG. 8 is a back view of the lift of FIG. 1 along arrow B;

FIG. 9 is a top view of the lift of FIG. 1 along arrow T;

FIG. 10 is a bottom view of the lift of FIG. 1 along arrow U:

FIG. 11 is an enlarged view of the cradle and carriage of the lift;

FIGS. 12A, 12B, 12C are enlarged views of the rail and swivel mounts pivoting to conform to different hull shapes of a cradle supported watercraft;

FIG. 13 is a side view of the arm with attached cradle detached from the lift frame;

FIG. 14 is a side partial cut-away view of the lift showing the fluid actuator holding the arm and cradle in a raised position;

FIG. 15 is another side partial cut-away view of the lift of FIG. 14 with arm and cradle in lowered position;

FIG. 16 is an enlarged side partial cut-way view of the carriage with rollers supported by the cradle;

FIG. 17 is an enlarged side view of the cylinder operated latch holding the arm of the lift in a raised position;

FIG. 18 is another view of FIG. 17 showing the latch in an open position and arm of the lift in a lowered position;

FIG. 19 is a schematic view of the controls for the single main fluid actuator for the lift arm and the fluid actuator for the latch of the preceding figures;

FIG. 20 is a side view of the lift in an up position attached to a side of a bulkhead;

FIG. 21 is an enlarged view of the swivel mount separated from swivel plate for use with the cradle and arm;

FIG. 22 is another view of FIG. 21 showing detached fasteners used for holding the arm in a fixed orientation position to the cradle;

FIG. 23 is another view of FIG. 22 showing the fasteners attached to the swivel plate and mount holding the arm in the fixed orientation position to the cradle;

FIG. 24 is a top view of the swivel plate, mount, cradle and arm of FIG. 23

FIG. 25 is a side view of the swivel plate, mount, cradle, arm of FIG. 24 along arrow X1;

FIG. 26 is a partial side elevation view of an alternate embodiment of a lifting device illustrating a cradle chock and cradle adjustably mounted to a lift arm assembly using a swivel adjustment member; and

FIG. 27 is a partial back side perspective vie of the embodiment of FIG. 26.

### DETAILED DESCRIPTION OF THE PREFERRED EMBODIMENTS

The present invention will now be described more fully hereinafter with reference to the accompanying drawings, in which preferred embodiments of the invention are shown. This invention may, however, be embodied in many different forms and should not be construed as limited to the embodiments set forth herein. Rather, these embodiments are provided so that this disclosure will be thorough and complete, and will fully convey the scope of the invention to those skilled in the art. Like numbers refer to like elements throughout, and prime notation is used to indicate similar elements in alternate embodiments.

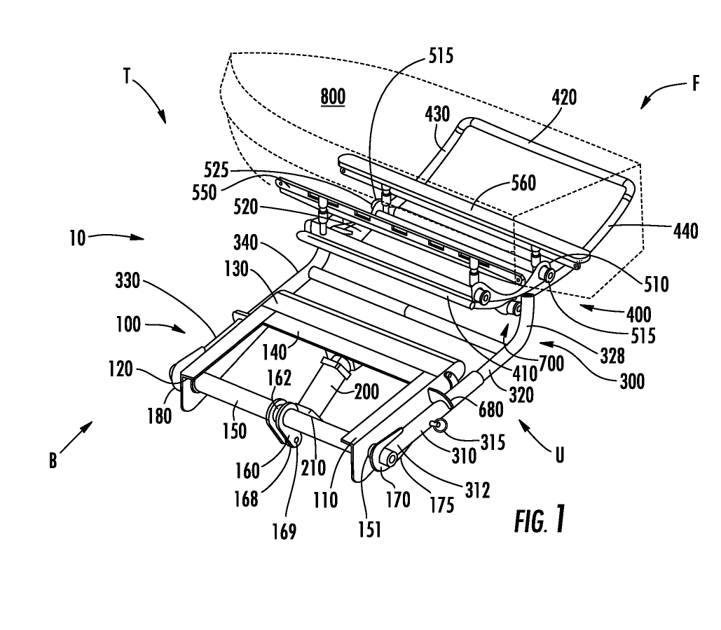

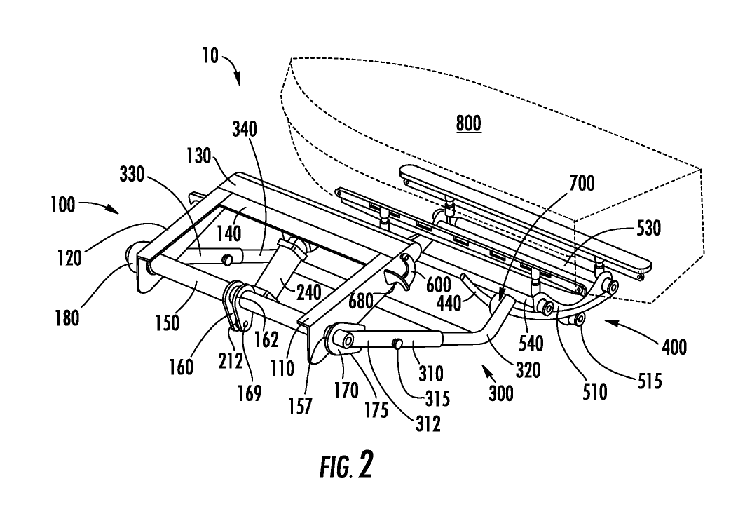

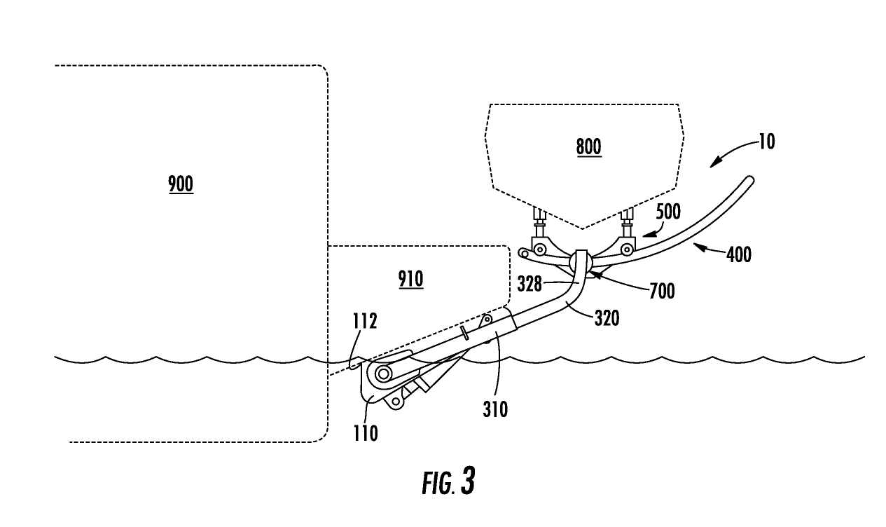

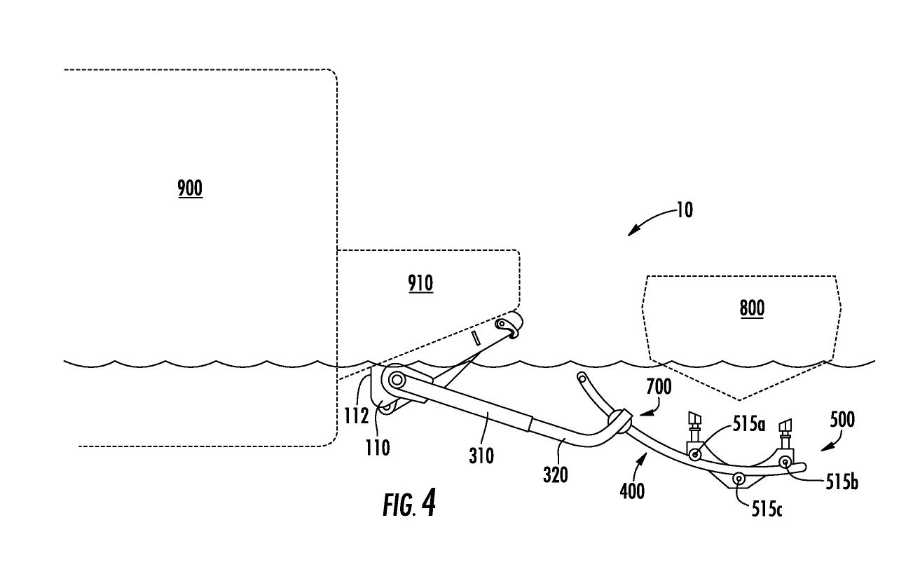

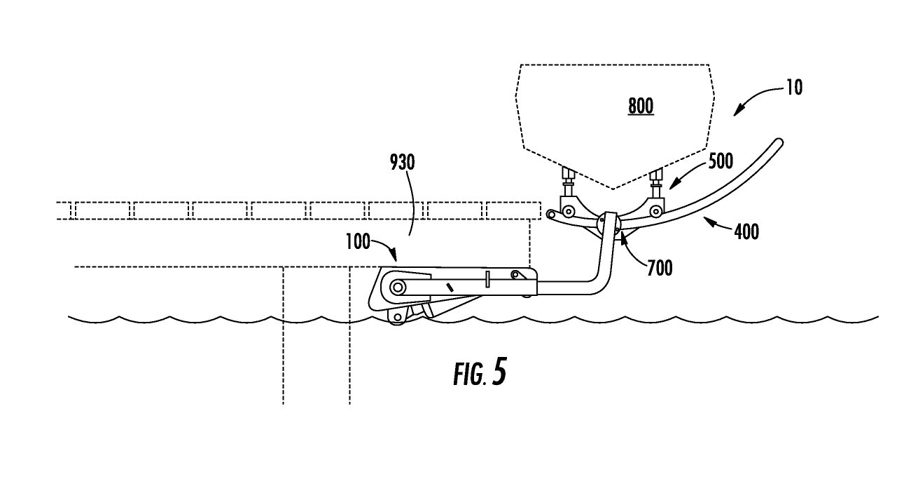

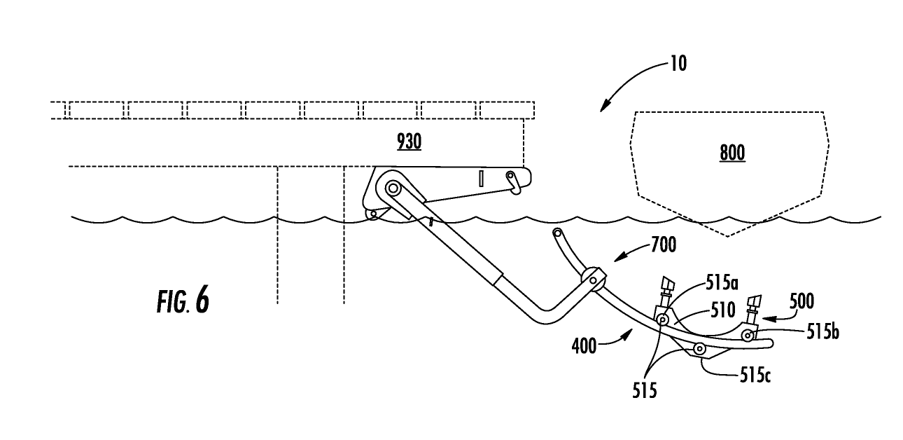

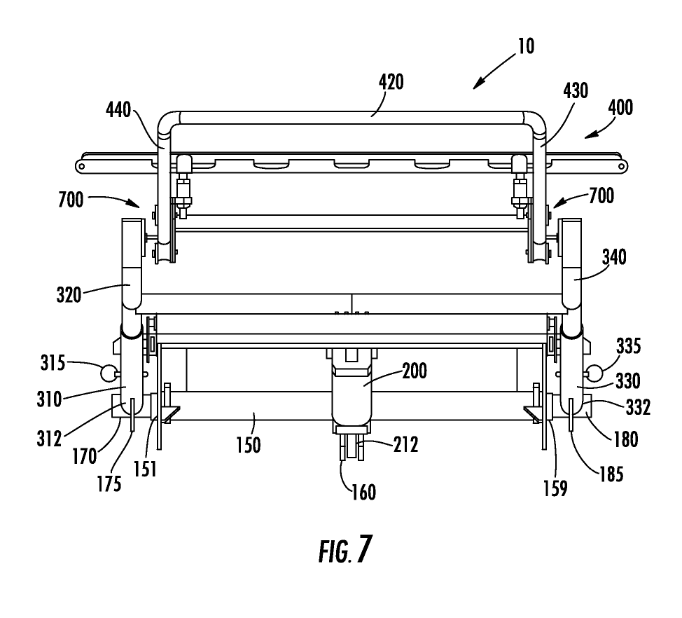

Referring initially to FIG. 1, a lifting apparatus 10 in keeping with the teachings of the present invention is herein described by way of example. FIG. 1 is a back perspective view of the lift 100 in an up position FIG. 2 is a back perspective view of the lift 100 of FIG. 1 in a down position. FIG. 3 is a side view of the lift 100 of the preceding figures in an up position attached to a transom (swim platform) 910 on the back of a larger boat 900. FIG. 4 is a side view of the lift 100 of FIG. 3 in a down position. FIG. 5 is a side view of the lift 100 in an up position attached to a dock 930. FIG. 6 is a side view of the lift 100 of FIG. 5 in a down position. FIG. 7 is a front view of the lift 100 of FIG. 1 along arrow F. FIG. 8 is a back view of the lift 100 of FIG. 1 along arrow B. FIG. 9 is a top view of the lift 100 of FIG. 1 along arrow T. FIG. 10 is a bottom view of the lift 100 of FIG. 1 along arrow U.

Referring to FIGS. 1, 2 and 7-10. the lift 100, generally includes a frame assembly 100, single main actuator 200 that raises and lowers lift arm assembly 300 that is in turn attached to a cradle 400 that has a rollable carriage 500 supported thereon.

Frame Assembly 100

Referring to FIGS. 1, 2 and 7-10, the lift 100 can include a frame assembly 100 having a generally rectangular configuration with a left bearing plate 110, right bearing plate 120, an L-shaped cross beam 140 connecting the bearing plates parallel to one another, and a protective nose shield 130 at a front end of the frame assembly 100. A rotatable crank shaft 150 can be inserted into through-holes of the bearing plates 110, 120 at a rear end of the frame assembly 100.

The ends of the crank shaft 150 are held in place to the bearing plates 110, 120 outer located left arm crank socket 170 and right arm crank socket 180. Bearings 151. 159 between crank sockets 170, 180 and bearing plates 110, 120 assist in allowing crank shaft 150 to be able to rotate in place.

Along a mid-portion of the crank shaft 150 can be an oblong shaped crank bracket 160 having an enlarged end 162 that is fixably attached about the mid-portion of the crank shaft 150. A downwardly protruding narrow end 168 of the crank bracket 160 can have a pivot point connection 169 that can be pivotally connected to one end 212 of the piston rod 210 of the main actuator 200.

Single Main Actuator 200

Referring to FIGS. 1, 2, and 7-10, the single main actuator 200 can be a single fluid cylinder and single piston that can be a hydraulic cylinder and piston. Alternatively, the single main actuator can be a pneumatic cylinder and piston. Main actuator 200 generally includes a piston 210 having a piston end 212 that is pivotally attached at a pivot point 169 to the narrow end 168 of crank bracket 160. The piston 210 can be fluid actuated to move in an out of a single cylinder 220. An other end of the cylinder 222 can be a rearwardly protruding portion 222 that is pivotally attached between parallel plates 230 that are fixedly mounted under a mid-portion of L-shaped cross beam 140.

Lift Arm Assembly 300

Referring to FIGS. 1, 2, 7-10, the lift 100 can include a lift arm assembly 300 can include a left lift arm 310 having an end 312 inserted in and fixedly attached to a U-shaped gusset portion 175 of left arm crank socket 170. A left extension member 320 can telescope relative to left lift arm 310 and be held to a selected extension length by a removable cotter type pin 315. The outer end 328 of left extension member 320 can bend 10 upward in and be attached by swivel mount assembly 700 to cradle 400.

Additionally, the lift arm assembly 300 can include a right lift arm 330 having an end 332 inserted and fixedly attached to a U-shaped gusset portion 185 of a right arm crank socket 180. A right extension member 340 can telescope relative to right lift arm 330 and be held to a selected extension length by another removable cotter type pin 335.

FIG. 13 is a side view of the left extension member 320 with attached cradle 400 detached from the frame assembly 100, by removing the cotter type pin 315.

Cradle 400

Referring to FIGS. 1, 2, 7-10, the lift I can include a cradle 400 that can have a generally rectangular configuration formed from two end beams 410, 420—that are connected to one another by concave curved side beams 430, 440. A swivel mount 700 can fixably attach the cradle 400 at a fixed orientation relative the ends 328, 348 of the telescoping arm extension members 320, 340.

Carriage 500

Referring to FIGS. 1, 2, 7-10, the lift I can include a carriage 500 that rolls on the concave curved side beams 430, 440 of cradle 400. Carriage 500 can include matching left arc curved bracket 510, and right arc-curved bracket 520. Each of the brackets may include a triangular arrangement of three sliding elements 515 for one side, 525 for opposing side mounted thereon. The sliding elements may comprise rollers 515a and 515b, as well as a sliding stop styled element 515c (similarly for opposing side elements 525) and are arranged so that two can rest and ride on the upper surface of concave curved side beams 430, 440, while a single element can rest and abut against a lower surface of the concave curved side beams 430, 440. Two parallel cross braces 530, 540 can connect the right and left arc-curved brackets to one another in a generally triangular arrangement.

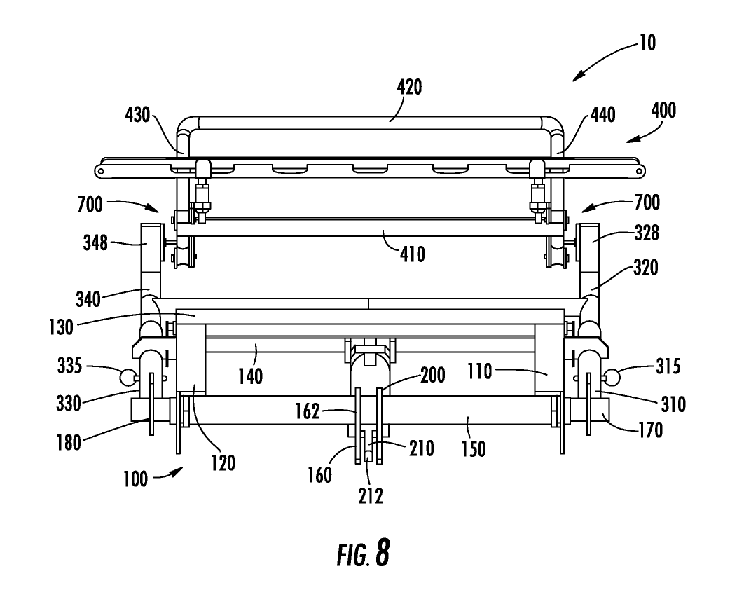

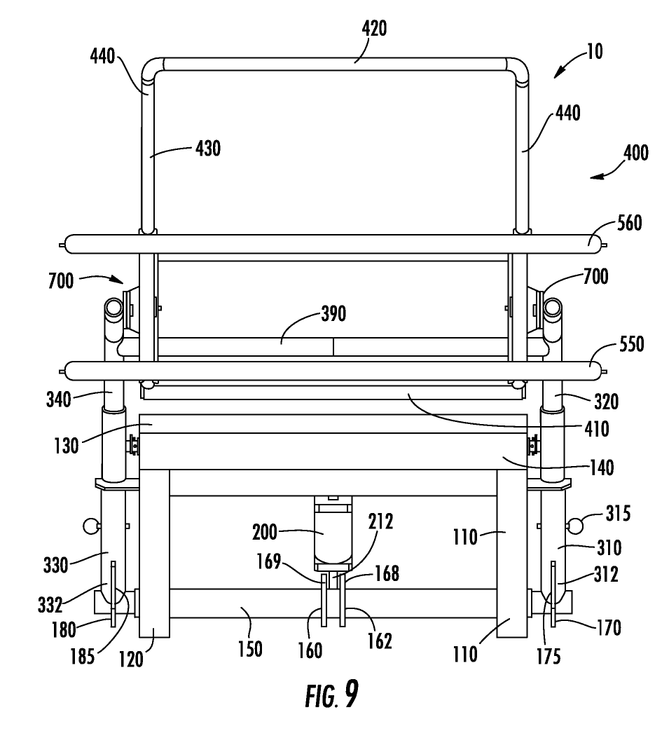

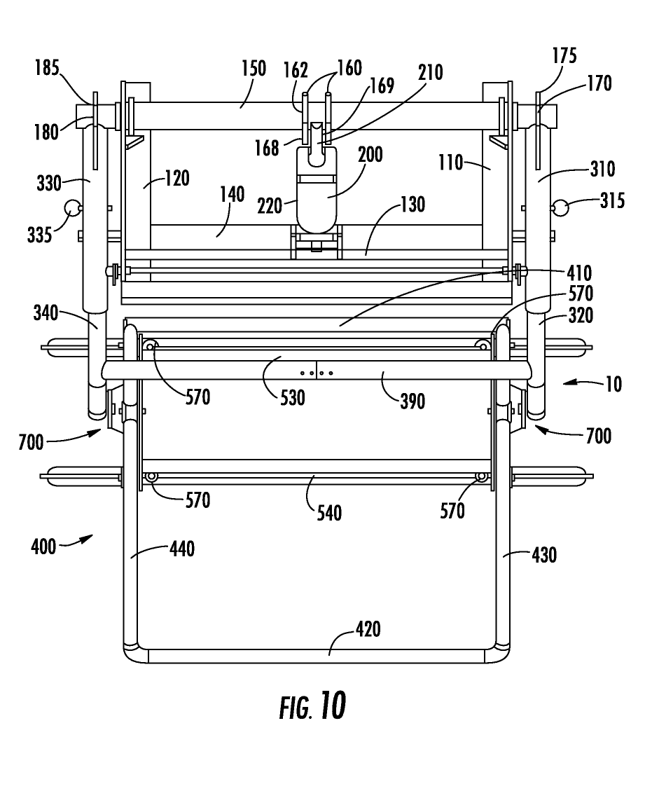

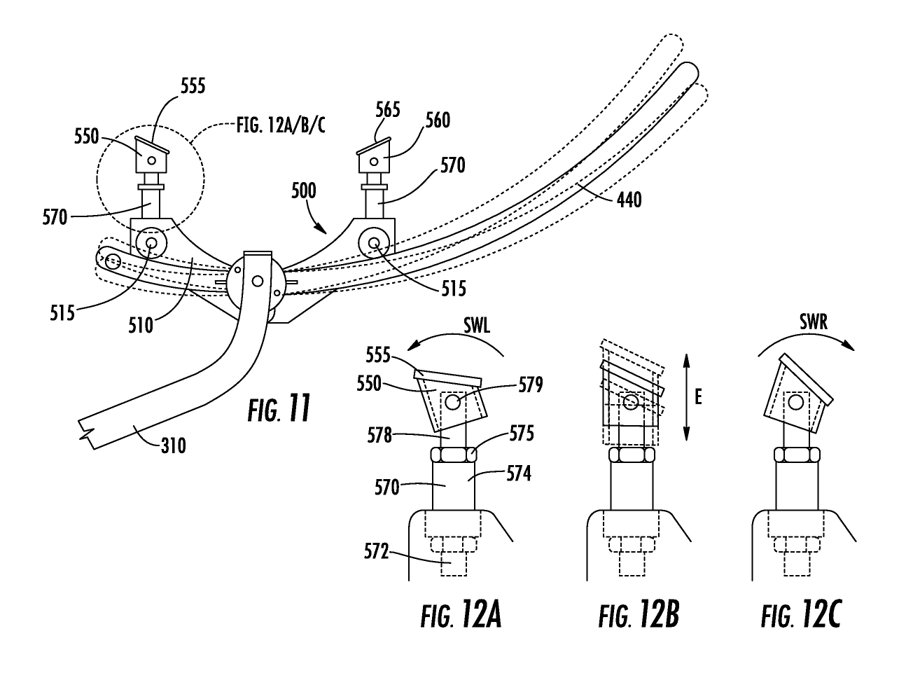

FIG. 11 is an enlarged view of the cradle 400 and carriage 500 of the lift 100. FIGS. 12A, 12B, 12C are enlarged views of the parallel watercraft support rails 550, 560 and swivel upright riser mounts 570 that pivot to conform to different hull shapes of a cradle supported watercraft 800.

Referring to FIGS. 1, 2, 7-12C, the arc-curved brackets 510, 520 can each include upright risers 570 that protrude upward from the ends of these brackets 510, 520. A total of approximately four identical upright risers 570 can be used, that each include a bottom end 572 that can be fastened by nuts and the like to the upwardly curved ends of the brackets 510, 520. A bottom cylinder portion 574 can have a nut that threadably locks 20 an extension rod portion 578 thereon, so that the rises can be extended or retracted in the direction shown by arrow E. The extension rod portion 578 can have a pivot pin portion 579 that pivotally attaches the risers to the inside of downwardly facing open channel of the horizontal railings 550, 560. The upper surface of the horizontal rails 555, 565 can have pads that can be plastic, rubber, and the like, that can be used as a protective surface for the hull surface portions of the watercraft being carried thereon.

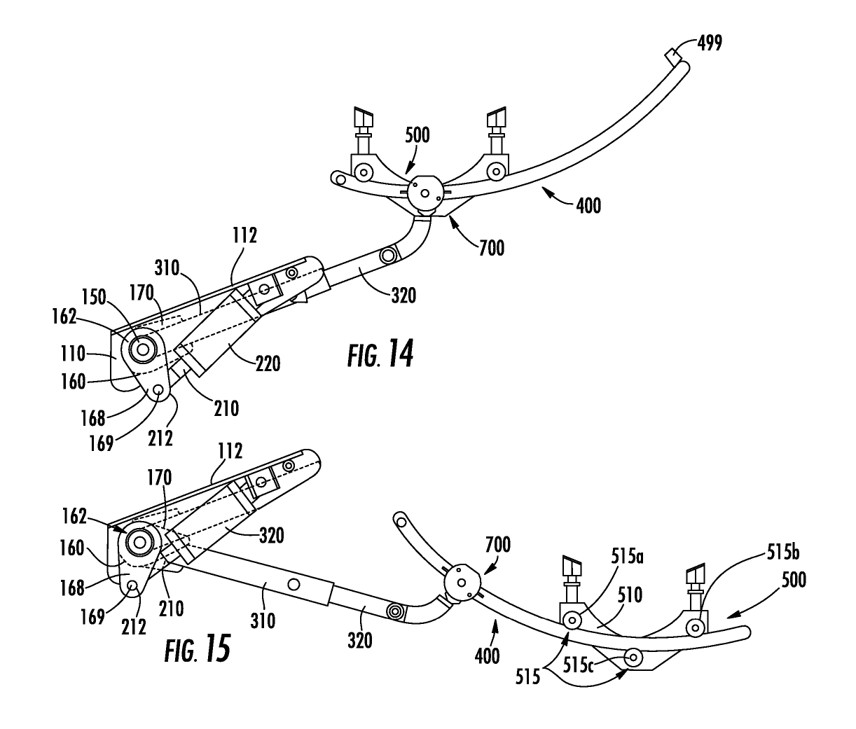

FIG. 16 is an enlarged side partial cut-way view of the arc-curved bracket 510 of the carriage 500 with triangular arrangement of three rollers 515 that is attached to and rolls relative to the concave curved side beam 440 of the cradle 400.

Latch Assembly 600

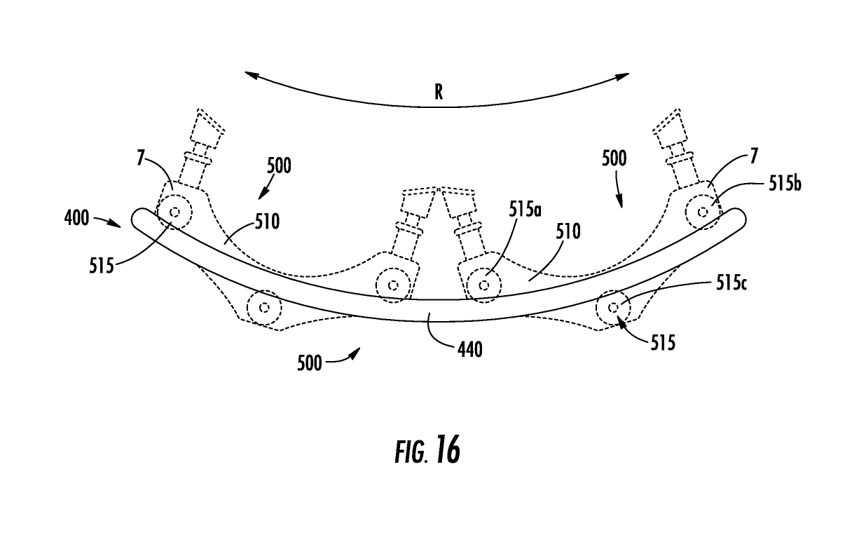

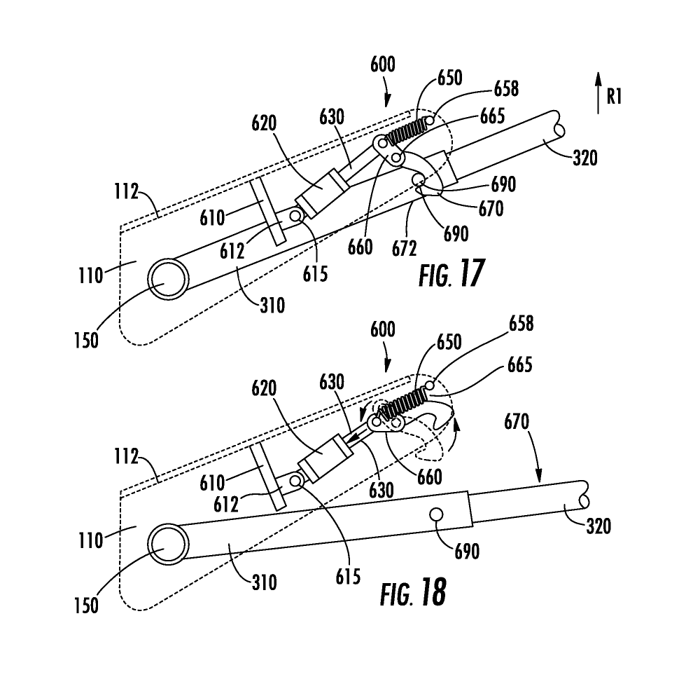

FIG. 17 is an enlarged side view of the cylinder operated latch assembly 600 holding the arm 310, 320 of the lift 100 in a raised position. FIG. 18 is another view of FIG. 17 showing the latch assembly 600 in an open position and arm 310, 320 of the lift 10.

Referring to FIGS. 1, 2, 13, 17, 18, the lift I can include a latch assembly 600 that allows the lifting arms 310/320, 330/340 to be locked as desired in a raised position. The left arm components 310/320 and the right arm components 330/340 can each include a latch assembly 600.

The latch assembly can include a support bracket 610 that downwardly protrudes from and is attached to flat plate portion 112 of bearing plate 110. A side protrusion portion 612 can extend sideways from the support bracket 610 and have a pivot pin connection to a rear end of a small fluid actuator 620 such as a small hydraulic cylinder, pneumatic cylinder and the like. A retractable piston 630 can extend from the opposite end of the cylinder 620 and have an end that is attached to both a latch spring 650 and an upwardly protruding end of an upper latch member 660, which has a lower end fixedly attached to a lower latch member hook 670. The opposite end of the latch spring 650 can be fixedly attached to a connector 658 on the side of bracket 110. The upper latch member and lower latch member hook 670 can be pivotally attached to the bracket 110 by a pivot pin connection 665.

Normally, the piston 630 of cylinder 620 can be pulled outward in an extended position by the bias of latch spring 650. As arm 310, 320 is being raised, a side protruding latch pin 690 on arm 310 can push against curved surface edge 672 of latch hook 670 so that the latch hook will result in hooking about the latch pin 690. A stopper member attached to the side of bracket 110 can limit the travel height of the lifting arms 310/320.

The operator can release the latch hook 670 by controlling cylinder 620 to retract 10 piston 630, which results in upper latch member 660 and lower latch hook pivoting about pivot pin 665, which unhooks the latch hook 670 from about latch pin 690, and will allow arm 310, 320 to be lowered.

Controls for Main Actuator and Small Latch Actuator

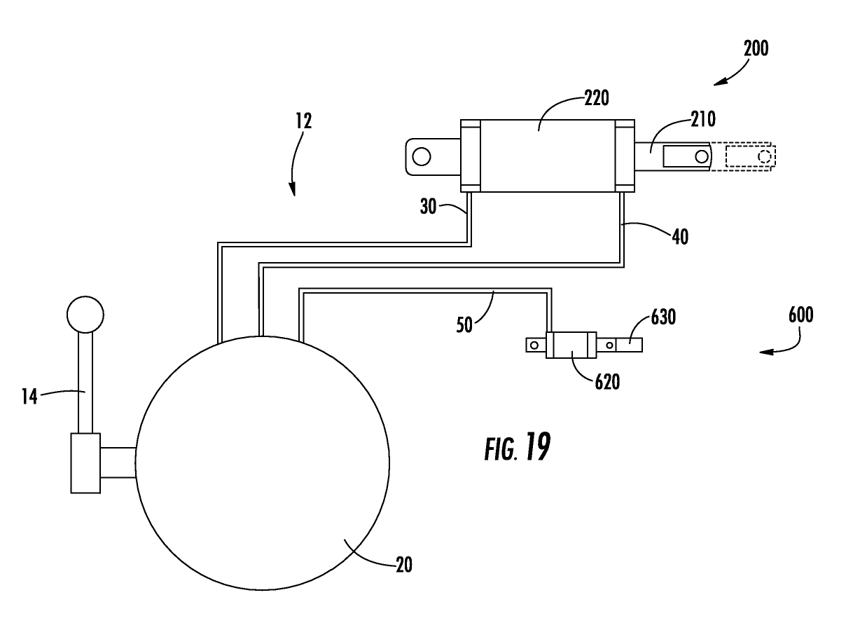

FIG. 19 is a schematic view of the controls 12 for the single main fluid actuator 200/210/220 for the lift arms 310/320, 330, 330 and the fluid actuator 620/640 for the latch assembly 600 of the preceding figures. A manual hand pump 14 can be connected to a power pack 20 such as a 12 volt/24 volt electro hydraulic power pack. Fluid actuation lines 30, 40, 50 can be used to actuate the pistons 210, 630 of the main actuator 200 and latch assembly cylinder 620. Conventional hydraulic controls such as that shown in U.S. Pat. No. 6,474,256 to Vogel, and U.S. Pat. No. 6,327,992 to Martin, which are both herein incorporated by reference can be used to control the actuators of the subject invention. The motors used to run the actuator(s) can include but not be limited to 120 volt power supply, battery power supply, solar power, and the like.

Swivel Mount Assembly 700

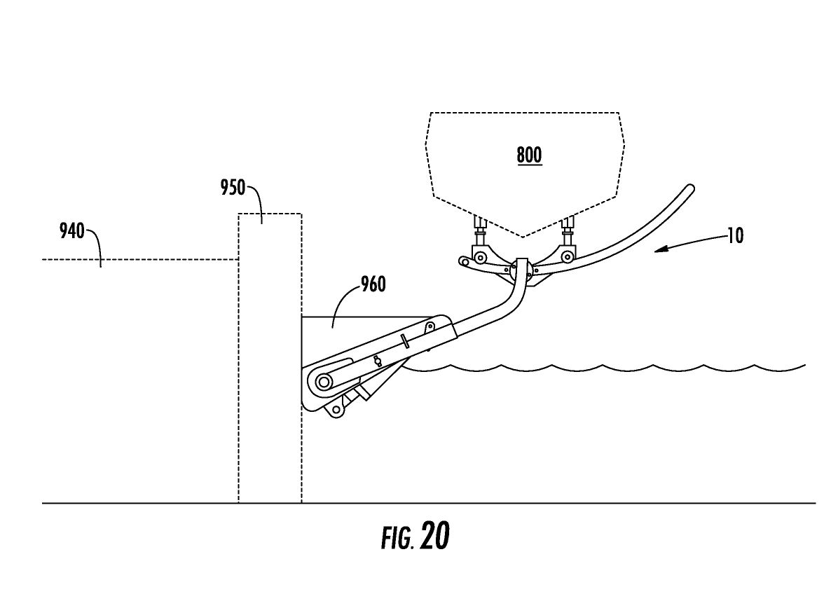

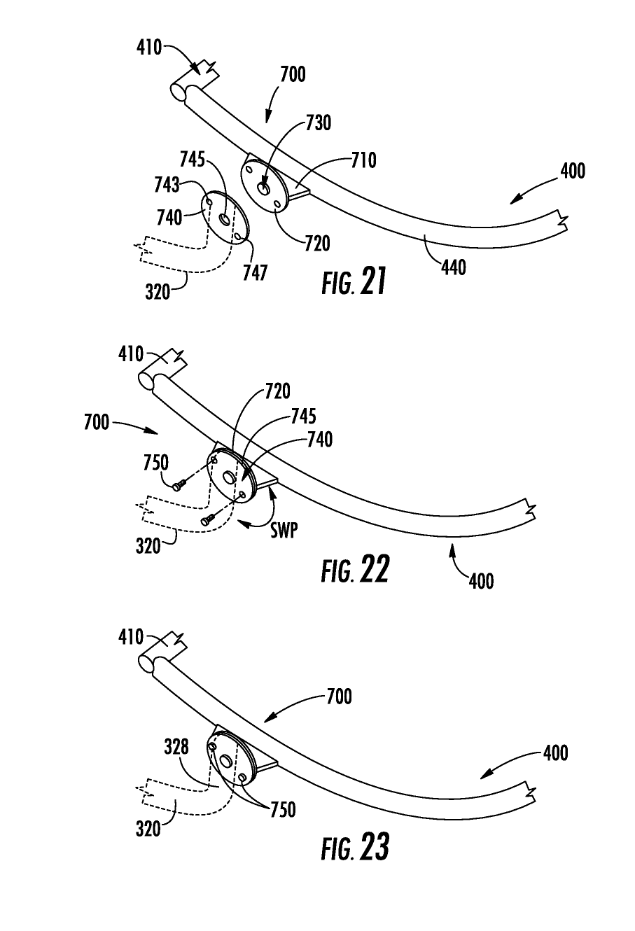

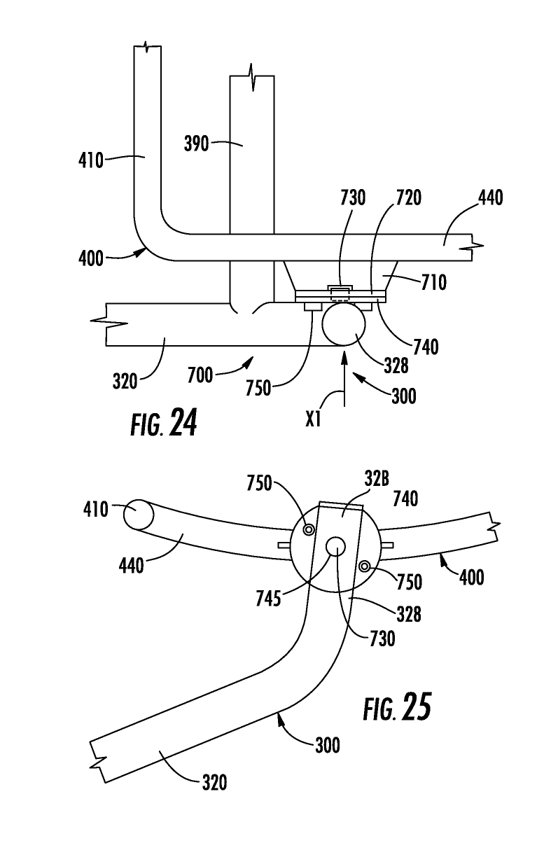

FIG. 21 is an enlarged view of the swivel mount 710 separated from swivel plate 740 for use with the cradle 400 and lifting arm 320. FIG. 22 is another view of FIG. 21 showing detached fasteners 750 such as bolts used for holding the arm 320 in a fixed orientation position to the cradle 400. FIG. 23 is another view of FIG. 22 showing the fasteners 750 attached to the swivel plate 740 and side plate 720 on the mount 710 holding the arm 320 in the fixed orientation position to the cradle 400. FIG. 24 is a top view of the swivel plate 740, side plate 720 on mount 710, cradle 400 and arm 320 of FIG. 23. FIG. 25 is a side view of FIG. 24 along arrow X1.

Referring to FIGS. 1, 2, 7-10 and 21-25, the swivel mount assembly 700. a mount 710 can be fixedly attached to both concave curved side beams 440 (only one is shown for simplicity) of cradle 400. A side plate 720 with flat exterior side can be fixed to the mount 710. In the middle of the plate 720 can be an outwardly protruding cradle pivot pin 730. Next the center hole 745 of the lift arm swivel plate 740 can be positioned over the cradle pivot pin 730.

When first installing the lift 10, the user can orient the upper curved ends 328 (only one is shown for simplicity) of the arms 320, 340 so that when the arms 310/320 and 330/340 of the lift are in a raised position on both sides of a horizontal exterior brace beam 390, the user can position the outer ends of the beams against the outside of the swivel plate 740.

The user can orient the cradle between the outer ends of the arms 310/320, 330/340 until the cradle is in a substantially level position while the arms 310/320, 330/340 are in the raised position. Next, the swivel plate 740 can be twisted clockwise or counter-clockwise in the direction of arrow SWP so that the side holes 743, 747 are positioned directly adjacent to side edges on opposite sides of the upper end 328 of the arm 320.

When the level orientation position of the cradle is reached, the user may drill through the existing side holes 743, 747 into plate 720 and then attach bolts through holes 743, 747, where the heads of the bolts 750 effectively lock the orientation of the cradle relative to the lift arms 310/320, 330/340.

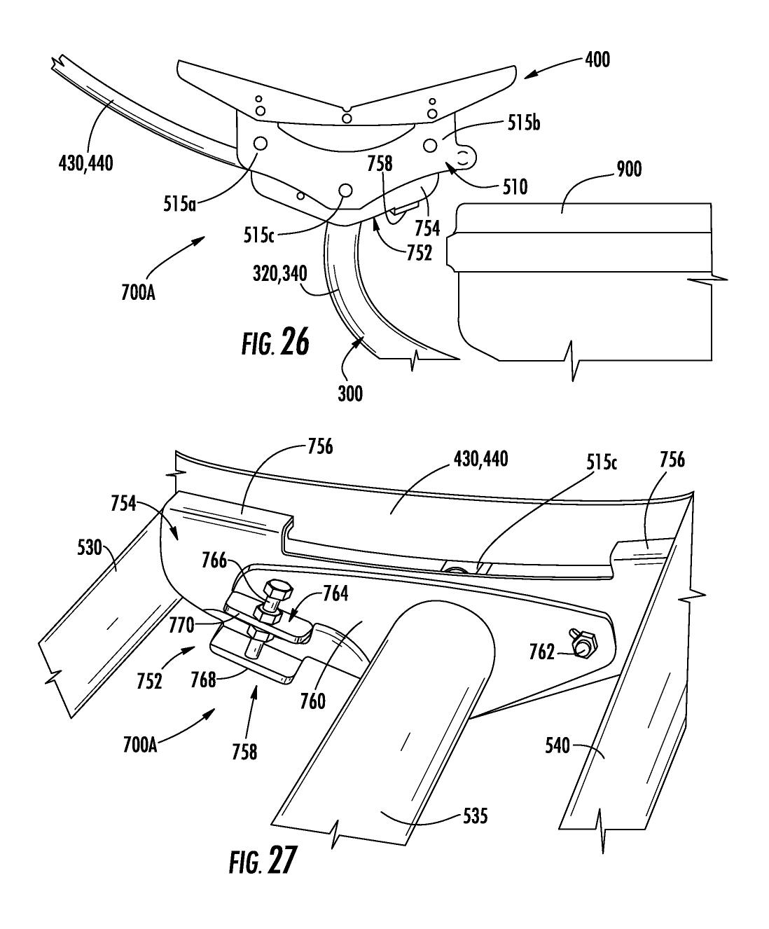

In an alternate embodiment and as illustrated with reference to FIGS. 26 and 27, the swivel mount assembly 700A may comprise a swivel mount 752 mounted to a free end of the arm 320 for fixing the cradle 400 at a preselected orientation. The swivel mount 752 may comprises a swivel plate 754 having a fastener 756 securing the arm 320 in a preselected orientation relative to the cradle 400. A swivel adjustment member 758 may include a rotatable plate 760 pivotal about a pivot pin 762 connected to the swivel plate 754. An adjustable fitting 764 provides adjusting means for rotating the rotatable plate 760 about the pivot pin 762 using a threaded bolt 766 moveable against a flange 768 carried by the swivel plate 754, by way of example, caliper styled screw, and the like for modifying the preselected orientation by a rotation of the rotatable plate 760 relative to the swivel plate 754, and this providing an orientation adjustment to the cradle 400. With continued reference to FIG. 27, the bolt 766 may extend through a threaded bore in a tab 770 carried by the rotatable plate 760 for biasing against the flange 768. Lock nuts 772 further securing the bolt 766 to the tab 770 may be used to secure the bolt in a preselected position. The swivel mount assembly 700A may be carried by a center cross brace 535 as illustrated with reference again to FIG. 27. One swivel adjustment member 758 may be attached on each end of the center cross brace 535 as desired.

Thus for the alternate embodiment 700A, the lift arms 320, 340 are affixed to the center cross brace 535 which is affixed to the swivel adjustment member 758. The swivel adjustment member 758 is pivotally connected to the swivel plate 754 at the pivot pin 762. The swivel plate 754 is affixed to the carriage 500 which rolls along the curved side beams 430, 440. As a result, rotation of the swivel adjustment member 758 through rotation of the bolt 766 changes the orientation of the carriage 500 relative to the left arms 320, 340 or side beams 430, 440 thus providing a leveling of the carriage as may be desired.

As further illustrated by way of example with reference again to FIG. 26, the cradle 400 may include cradle chocks 551 in place of the support rails 550, 560 as earlier described. Yet further, a combination of chock and rail may be employed as desired.

Operation

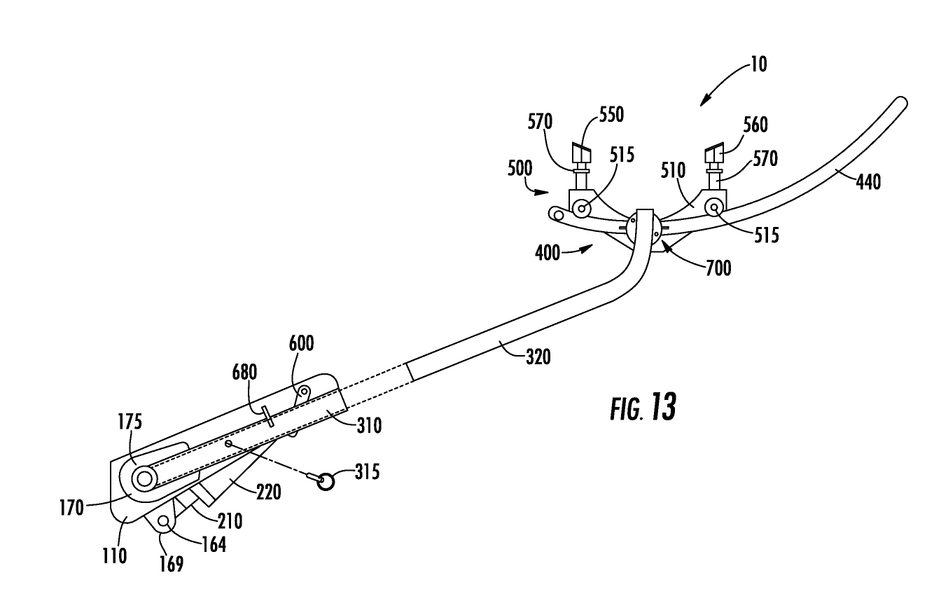

A preferred application of the invention is using the novel lift with a larger vessel for raising and lowering smaller watercrafts therefrom. FIG. 14 is a side partial cut-away view of the lift 10 showing the fluid actuator 200 holding the arm 310/320 and cradle 400 in a raised position. FIG. 15 is another side partial cut-away view of the lift 10 of FIG. 14 with arm 310/320 and cradle 400 in lowered position.

Referring to FIGS. 1-4, 14 and 15 top flat plate portions 112, 122 of the bearing plates 110, 120 can be used to flush mount the frame assembly 100 by fasteners such as conventional bolts (not shown) underneath an angled bottom of a boat transom (swim platform 910) that is attached to a larger vessel 900. In the raised position a small personal watercraft 800 such as but not limited to a jet ski or inflatable can be supported by the hull conforming pivotal rails 550, 560, on the carriage 500 in a substantially level position.

To lower the carriage 500 and cradle 400, a single piston 210 from main cylinder 220 can move from a retracted position to an extended position and move narrow end 168 of crank bracket 160 at pivot point 169. The enlarged end 162 of the crank bracket being fixedly attached to crank shaft 150 effectively rotates the crank shaft 150 in a clockwise direction. Since the bottom ends of arms 310, 330 are fixedly attached to crank sockets 170, 180 which are in turn fixedly attached to ends of the crank shaft 150, the lift arms 310/320, 330, 340 move downward lowering cradle 400. As the cradle 400 is lowered into the water, the carriage 500 can roll off the curved side beams 430, 440 of the carriage by gravity and effectively allow the watercraft 800 to slip easily and safely into the water.

Retracting the piston 210 into actuator cylinder 220 reverses the operation allowing the cradle 400 to rise upward. An optional stopper-bumper on the cradle 400 can prevent the carriage 500 from fully rolling off of the cradle.

Another application of the novel lift is attaching the frame assembly portion underneath a horizontal surface. FIG. 5 is a side view of the lift 10 in an up position attached to a dock 930. FIG. 6 is a side view of the lift 10 of FIG. 5 in a down position. The ends 320/340 of the arms can be bent to allow the cradle to support the watercraft 800 in substantially level positions. The operation is similar to that previously described.

Another application of the novel lift is attaching the frame to a wall by using an adapter such as a triangular adapter type bracket 960. FIG. 20 is a side view of the lift 10 of the preceding figures in an up position attached to a side wall 950 of a bulkhead 940. The operation of the lift can also be similar to that previously described.

The components used to make the lift can include but are not limited to stainless steel, galvanized steel, plastics, composites, combinations thereof, and the like.

The main actuator for the raising and lowering the arm(s), and the latch actuator, can be a fluid actuator such as but not limited to hydraulic, pneumatic, seawater, city water pressure supplies, and the like.

The lift can lift personal watercrafts having weights of up to approximately 800 to approximately 1,500 pounds or more. Using different sized components such as the actuators and the arms) can be used to lift larger craft such as but not limited to actual pleasure boats, manned submersibles, unmanned submersibles, that can weigh up to several tons or more.

Although the invention has been described as having a separate crank bracket for the main actuator and separate crank sockets for the arms, the invention can use a single bracket that is connected to both the actuator and the arms and to the crank shaft. For example, an L-shaped bracket where the angled corner of the L is fixed to the shaft and the outer legs of the L are each attached to the actuator and to control the raising and lowering of one or more arm(s) can be used. The actuator can be used to rotate the shaft component which can then raise and lower the arm or arms.

Many modifications and other embodiments of the invention will come to the mind of one skilled in the art having the benefit of the teachings presented in the foregoing descriptions and the associated drawings. Therefore, it is understood that the invention is not to be limited to the specific embodiments disclosed, and that modifications and embodiments are intended to be included within the scope of the appended claims.

That which is claimed is:

1. A lifting apparatus comprising:
a frame;
an arm having proximal and distal ends, wherein the proximal end is rotatably connected to the frame;
a cradle carried by the arm distal end, wherein rotation of the arm lowers and raises the cradle;
a carriage slidable on an upper surface of the cradle; and
upper and lower sliding elements attached to the carriage, wherein at least two upper elements include a roller for riding along the upper surface of the cradle, and wherein at least one lower element is operable along a lower surface of the cradle, the upper and the lower elements allowing the carriage to slide along the cradle in a substantially level position while the cradle is being raised and lowered by the arm rotation.

2. A lifting apparatus according to claim 1, further comprising a single actuator operable between the frame and the arm for rotation of the arm.

3. A lifting apparatus according to claim 2, wherein the actuator includes a pneumatic cylinder and actuated piston.

4. A lifting apparatus according to claim 1, wherein the cradle includes:
a concave curved surface on the cradle wherein the carriage is positioned on the concave curved surface of the cradle, the carriage allowing the watercraft to remain in a substantial level position while the arm and the attached cradle are being raised and lowered.

5. A lifting apparatus according to claim 1, wherein the elements comprise
a first set of three rollers arranged in a triangular pattern on one side of the carriage, and
a second set of three rollers arranged in a triangular pattern on another side of the carriage.

6. A lifting apparatus according to claim 1, the carriage further comprising:
upright supports pivotally attached to the carriage, the pivotal upright supports allowing a water craft to be supported in a stable position to the carriage.

7. A lifting apparatus according to claim 1, further comprising:
a swivel mount for locking the cradle to the arm.

8. A lifting apparatus according to claim 1, further comprising:
a swivel mount for locking the cradle to the arm, wherein the swivel mount includes:
a swivel plate having a fastener for holding the arm in a selected fixed orientation position relative to the cradle.

9. A lifting apparatus according to claim 8, wherein the fastener includes:
a first fastener along one side of the arm; and
a second fastener along another side of the arm, wherein the first and the second fasteners lock the cradle in the selected fixed orientation position relative to the cradle.

10. A lifting apparatus for raising and lowering water crafts, comprising:
a frame attached to a support;
an arm rotatably attached to the frame;
a cradle attached to a free end of the arm, the cradle having a curved surface thereon;
a self leveling carriage slidable along the curved surface of the cradle;
a plurality of elements arranged in a triangular pattern on the carriage, the plurality of elements allowing the carriage to slide relative to the cradle and allow the carriage to support a watercraft thereon in a substantial level position while the arm and the attached cradle are being raised and lowered by the actuator.

11. A lifting apparatus according to claim 10, wherein at least one of the plurality of elements includes a lower roller riding against a lower surface of the cradle and at least two upper rollers allowing the carriage to roll along the upper surface of the cradle and allow the carriage to support a watercraft thereon in a substantial level position while the arm and the attached cradle are being raised and lowered by the arm.

12. A lifting apparatus according to claim 11, wherein the cradle includes:
an upper concave curved surface; and
a lower convex curved surface.

13. A lifting apparatus comprising:
a frame;
an arm having proximal and distal ends, wherein the proximal end is rotatably connected to the frame;
a cradle carried by the arm, wherein rotation of the arm lowers and raises the cradle;
a carriage slidable on the cradle; and
a swivel mount locking the cradle to the arm, wherein the swivel mount is adjustably mounted to the arm for fixing the cradle at a preselected orientation thereto.

14. A lifting apparatus according to claim 13, wherein the swivel mount comprises:
a swivel plate having a fastener securing the arm in a preselected orientation relative to the cradle;
a swivel adjustment member pivotally connected to the swivel plate; and
an adjustment fitting carried by the swivel adjustment member for modifying the preselected orientation by a rotation of the swivel adjustment member relative to the swivel plate.

15. a lifting apparatus according to claim 14, wherein the adjustment member comprises:
a rotatable plate pivotally connected to the swivel plate; and
an adjustment element biased between the swivel plate and the rotatable plate for modifying an orientation relationship therebetween.

16. A lifting apparatus according to claim 13, wherein the swivel mount comprises:
a side plate fixedly attached to the cradle;
a swivel plate fixedly attached to a free end of the arm, the swivel plate mating with the side plate for slidable movement therewith; and
a fastener securing the side plate to the swivel plate in the preselected orientation.

17. A lifting apparatus according to claim 13, further comprising upper and lower sliding elements attached to the carriage, wherein at least two upper elements include operate along the upper surface of the cradle, and wherein at least one lower element is operable along a lower surface of the cradle, the upper and the lower elements allowing the carriage to slide along the cradle in a substantially level position while the cradle is being raised and lowered by the arm rotation.

18. A lifting apparatus according to claim 16, wherein the at least two upper sliding elements comprise rollers.
